(19) United States
(12) Patent Application Publication
(10) Pub. No.: US 2006/0211360 A1
(43) Pub. Date: Sep. 21, 2006

(54) Refreshment cell

(75) Inventors: Anna Bauch, Hamburg (DE); Oliver Doebertin, Hamburg (DE); Alexander Niesigk, Buchholz (DE); Hermann Schotte, Buxtehude (DE)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Airbus Deutschland GmbH, Hamburg (DE)

(21) Appl. No.: 11/334,934

(22) Filed: Jan. 19, 2006

Related U.S. Application Data
(60) Provisional application No. 60/644,965, filed on Jan. 19, 2005.

(30) Foreign Application Priority Data
Jan. 19, 2005 (DE) 10 2005 002 543.9

(51) Int. Cl. B64D 13/00; B64D 11/00

(52) U.S. Cl. 454/76; 244/118.5

(57) ABSTRACT

A refreshment cell for use in an aircraft cabin comprises an air shower in combination with a humidifying element.

### CROSS-REFERENCE TO RELATED APPLICATIONS

### BACKGROUND OF THE INVENTION

This application claims the benefit of the filing date of U.S. Provisional Patent Application No. 60/644,965 filed Jan. 19, 2005, the disclosure of which is hereby incorporated herein by reference.

The invention generally relates to a refreshment cubicle, particularly to a refreshment cell for use in an aircraft cabin.

Genuine refreshment cubicles are usually not provided in aircraft cabins for business-class and economy-class passengers. Passengers of these classes currently utilize the toilets and the laboratories for refreshment purposes. Most toilets and lavatories are heavily soiled during the course of a flight such that a corresponding build-up of odors occurs.

With respect to first-class and VIP customers, there exist various options for integrating a fresh water shower on board an aircraft. However, since these showers require that large quantities of fresh water be made available, the weight to be carried along is increased accordingly.

### SUMMARY OF THE INVENTION

According to an exemplary embodiment, a refreshment cell for an aircraft is provided comprising an air shower which blows out air and a humidifier for humidifying the air blown out of the air shower. This may provide for a refreshment cell that requires little water and does not have the above-mentioned disadvantages.

The refreshment cell according to an exemplary embodiment of the invention also provides a refreshment option for business-class and economy-class passengers because only small quantities of water are consumed due to the utilization of air showers in combination with humidifiers.

According to the invention, the air shower comprises, for example, of a plurality of air jets that blow air into the refreshment cell. The humidifier comprises, for example, an air jet and a humidifying medium for changing the air humidity of the refreshment cell.

According to the invention, aromatics can also be delivered into the refreshment cell. This can be realized, for example, by adding the aromatic to the air current of an air jet. This air jet may form part of the air shower or an air jet of the humidifier or be realized in the form of a separate air jet.

In order to increase the refreshment sensation, it may be possible to vary the velocity of the air current being blown into the interior of the refreshment cell. This can be realized by utilizing air jets that blow out air with different velocities or by varying the outflow velocity of an individual air jet. This air jet may form part of the air shower or an air jet of the humidifier or be realized in the form of a separate air jet.

According to another exemplary embodiment of the invention, the refreshment cell alternatively or additionally comprises a lighting element for illuminating the interior of the refreshment cell, for example, with varicolored light.

In order to additionally improve the refreshment sensation of a passenger who utilizes the refreshment cell, a loudspeaker for realizing an acoustic irradiation with sounds and music may be installed into the refreshment cell in accordance with another exemplary embodiment of the invention.

The additional use of varicolored light and sounds/aromatics serves for noticeably broadening the sphere of perception and makes it possible for the passenger to experience a new type of refreshment sensation independently of the actual use of water.

The refreshment cell according to an exemplary embodiment of the invention is realized, for example, in the form of a complete module/compartment analogous to an existing toilet unit in aircraft. Consequently, the cell can be integrated into an aircraft instead of a refreshment room or a toilet unit or as a supplement to existing conventional toilets.

The refreshment cell according to an exemplary embodiment of the invention may provide any passenger with the option to individually refresh oneself, in particular, independently of lavatories and toilets. The refreshment cell does not have the purpose of providing the passengers with an alternative washing facility, but rather of enabling the passengers to experience a freshness sensation analogous to that of a shower by means of a controlled delivery and combination of aromatics, light and sounds. The passenger should not have to undress for this purpose in order to save time and effort.

### BRIEF DESCRIPTION OF THE DRAWINGS

An exemplary embodiment of the invention is elucidated below with reference to the enclosed figures. The figures show:

FIG. 1A, a schematic cross-sectional representation of one preferred embodiment of a refreshment cell according to the invention; and

FIG. 1B, a top view of the refreshment cell according to FIG. 1A.

### DETAILED DESCRIPTION

In the figures, identical and corresponding components are identified by the same reference symbols.

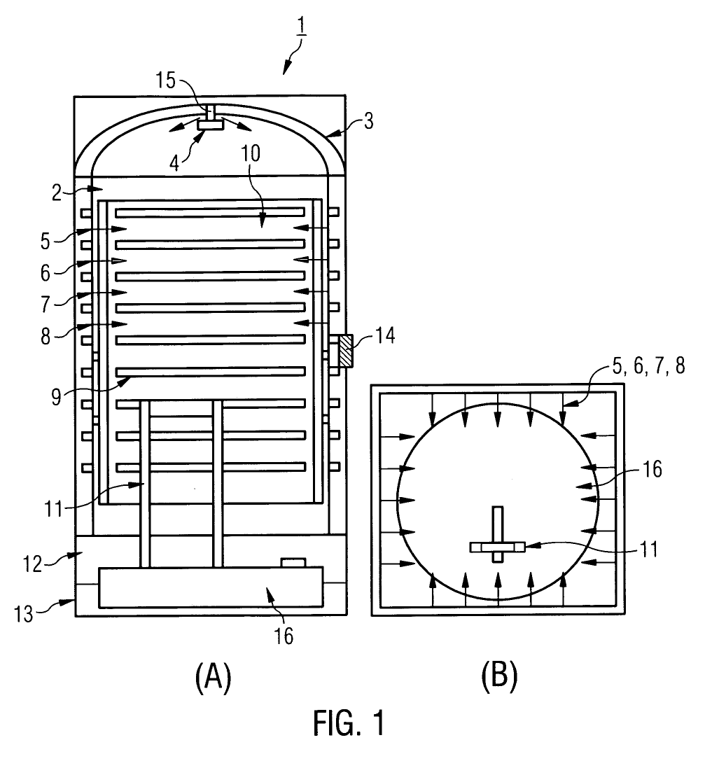

FIG. 1A shows a schematic cross-sectional representation of an exemplary embodiment of a refreshment cell 1. FIG. 1A shows that the refreshment cell 1 is realized, for example, in the form of a complete module/compartment analogous to an existing toilet unit.

The refreshment cell 1 shown in FIG. 1A has walls 2 in order to form a preferably enclosed space, in which a passenger can refresh oneself in an undisturbed fashion.

FIG. 1A shows that the refreshment cell 1 is provided with an air jet 4 that is arranged on the ceiling of a dome 3 of the refreshment cell 1 and serves for producing an air shower. The air jet 4 blows air into the interior of the refreshment cell from above.

On lateral regions of the refreshment cell 1 there is situated, for example, an air jet 5 in the form of an aromatizer in order to deliver aromatics into the refreshment cell 1. These aromatics can also be blown in through the air jet 4.

Underneath the air jet 5 there is situated an air jet 6 in the form of a humidifier in order to adjust the air humidity in the refreshment cell 1. The air humidity is preferably maintained so low that a passenger can remain dressed while using the refreshment cell 1. Likewise, the air jets 4 and 5 can also be used for adjusting the humidity level by blowing humid air into the interior of the refreshment cell 1.

The refreshment cell 1 according to FIG. 1 also features an air jet 7 that blows, for example, a very strong air current into the refreshment cell 1. An air jet 8 that blows, for example, a very weak air current into the refreshment cell 1 is arranged directly underneath the strong air jet 7. Due to the different flow velocities of the air being blown into the refreshment cell through the individual air jets, the passenger experiences the sensation of a breeze and the refreshment sensation is intensified. It would also be possible to alternatively or additionally vary the velocity of the air blown into the cell through the air jets 4, 5 and 6 in order to achieve the same effect.

The refreshment cell 1 shown in FIG. 1A features, for example, LED lighting strips 9 that are arranged, for example, on a translucent glass pane 10. The translucent glass pane 10 has openings for the individual air currents/the aromatization/the humidification.

The refreshment cell 1 also features a seat frame 11 that essentially extends vertically from a floor region 12 to the dome 3 of the refreshment cell 1. The seat frame is realized, for example, in a height-adjustable fashion and can be accordingly adjusted for use as a seat by the user of the refreshment cell 1.

In addition, a dehumidification pan 13 is situated in the floor region 12 of the refreshment cell 1. The humidification/dehumidification in the refreshment cell 1 is controlled in an autarkic fashion, for example, by means of the dehumidification pan 13 with special dehumidification technology, for example, runoff or the like.

FIG. 1A shows that an input device 14 is arranged on a lateral wall of the refreshment cell. This input element consists, for example, of a keypad, a touch screen, etc. This input device 14 enables a user of the refreshment cell 1 to select, for example, a corresponding program (scene) that fulfills the passenger's refreshment needs with respect, for example, to heat, freshness, chilliness, etc.

The corresponding control of the humidification, the fragrance, the air flow velocity, the lighting, etc., makes it possible to simulate the refreshment sensation desired by the user without actually consuming any water.

The refreshment cell 1 may contain, for example, an audio unit 15 that is accommodated in the dome 3 of the refreshment cell 1 in order to enable the user to experience surround sound.

The audio unit 15 makes it possible, for example, to acoustically irradiate the refreshment cell 1 with the sound of breaking waves.

Aromas, colors, the air humidity and the sound are adapted to one another in accordance with the refreshment sensation (scene) selected by the user.

A user enters the refreshment cell 1, for example, through a conventional toilet door in an aircraft. Once the refreshment room is activated via the touch screen 14 and a scene has been selected in accordance with personal needs, the user steps into the center of the refreshment room and may sit down on the seat frame 11 that is situated on a turntable 16 as shown in FIG. 1B. The turntable 16 is turned with a predetermined speed in accordance with the selected scene.

After the start key is pressed, the system begins to execute the predefined scene selected within a defined time interval. Once the scene is completed, the passenger exits the refreshment room 1 and the room is immediately available for the next customer.

Although the invention was described above with reference to one preferred embodiment, it should be understood that the invention can also be modified and changed without deviating the scope of protection of the invention as long as an air shower is used in combination with humidifying elements. For example, the individual air jets can be arranged arbitrarily in order to induce a corresponding refreshment sensation in the user. A plurality of air jets may be arranged, for example, circumferentially on the wall of the refreshment cell. The humidifying element may be realized arbitrarily as long as it is able to humidify the interior of the refreshment cell. In addition, the refreshment cell is not only suitable for use on aircraft, but also, for example, on buses, rail vehicles, ships, etc.

It should be added that “comprising” does not exclude any other elements or steps, and that “a” or “an” does not exclude a plurality. It should also be noted that characteristics or steps that were described with reference to one of the embodiments elucidated above can also be used in combination with other characteristics or steps of the other described embodiments. The reference symbols in the claims should not be understood in a restrictive sense.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A refreshment cell for use in an aircraft cabin, comprising:
an air shower for blowing out air; and
a humidifier for humidifying the air blown out of the air shower.

2. The refreshment cell of claim 1, wherein the humidifier comprises an air jet that blows humid air into the refreshment cell.

3. The refreshment cell of claim 1, further comprising an aromatizer for delivering aromatics into the refreshment cell.

4. The refreshment cell of claim 1, further comprising air jets for blowing air into the refreshment cell with different velocities.

5. The refreshment cell of claim 1, further comprising at least one light for illuminating an interior of the refreshment cell.

6. The refreshment cell of claim 5, wherein the light is realized behind a pane that comprises of a transparent material in order to display lighting effects in the refreshment cell.

7. The refreshment cell of claim 6, wherein the pane features openings, through which the air can be blown into the refreshment cell.

8. The refreshment cell of claim 1, further comprising a loudspeaker for the acoustic irradiation of the interior of the refreshment cell.

9. The refreshment cell of claim 1, further comprising a dehumidifier for dehumidifying the air in the refreshment cell.

10. The refreshment cell of claim 1, further comprising a turntable for turning a person using the refreshment cell.

11. The refreshment cell of claim 1, further comprising an input device for selecting a scene, to which are assigned at least one of flow velocity of the air blown into the refreshment cell, a humidity level of the air in the refreshment cell, a color/color scenario for illuminating the interior of the refreshment cell and a sound to be acoustically irradiated into the refreshment cell.

12. The refreshment cell of claim 5, wherein said light has a selectable color.
